(19) United States
(12) Patent Application Publication
(10) Pub. No.: US 2007/0098083 A1
(43) Pub. Date: May 3, 2007

(54) Supporting fidelity range extensions in advanced video codec file format

(76) Inventors: Mohammed Zubair Visharam, Santa Clara, CA (US); Ali Tabatabai, Cupertino, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/255,853

(22) Filed: Oct. 20, 2005

(51) Int. Cl. H04N 7/12

(52) U.S. Cl. 375/240.26

(57) ABSTRACT

A parameter set is created to specify chroma format, luma bit depth, and chroma bit depth for a portion of multimedia data. The parameter set is encoded into a metadata file that is associated with the multimedia data. The parameter set is extracted from the metadata file if a decoder configuration record contains fields corresponding to the parameter set. In another aspect, the decoder configuration record is created with fields corresponding to the parameter set.

### RELATED APPLICATIONS

This application is related to U.S. patent application Ser. Nos. 10/371,434, 10/371,438, 10/371,464, and 10/371,927, all filed on Feb. 21, 2003, and Ser. Nos. 10/425,291 and 10/425,685, both filed on Apr. 28, 2003, all of which are assigned to the same assignees as the present application.

### FIELD OF THE INVENTION

The invention relates generally to the storage and retrieval of audiovisual content in a multimedia file format and particularly to file formats compatible with the ISO media file format.

### COPYRIGHT NOTICE/PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright© 2003, Sony Electronics, Inc., All Rights Reserved.

### BACKGROUND OF THE INVENTION

In the wake of rapidly increasing demand for network, multimedia, database and other digital capacity, many multimedia coding and storage schemes have evolved. One of the well known file formats for encoding and storing audiovisual data is the QuickTime® file format developed by Apple Computer Inc. The QuickTime file format was used as the starting point for creating the International Organization for Standardization (ISO) Multimedia file format, ISO/EEC 14496-12, Information Technology—Coding of audio-visual objects—Part 12: ISO Media File Format (also known as the ISO file format). The ISO file format was, in turn, used as a template for two standard file formats: (1) the MPEG-4 file format developed by the Moving Picture Experts Group, known as MP4 (ISO/IEC 14496-14, Information Technology—Coding of audio-visual objects—Part 14: MP4 File Format); and (2) a file format for JPEG 2000 (ISO/IEC 15444-1), developed by Joint Photographic Experts Group (JPEG).

The ISO media file format is a hierarchical data structure. The data structures contain metadata providing declarative, structural and temporal information about the actual media data. The media data itself may be located within the data structure or in the same file or externally in a different file. Each metadata stream is called a track. The metadata within this track contains the structural information providing references to the externally framed media data.

The media data referred to by a meta-data track can be of various types (e.g., video data, audio data, binary format screen representations (BIFS), etc.). The externally framed media data is divided into samples (also known as access units or pictures. A sample represents a unit of media data at a particular time point and is the smallest data entity which can be represented by timing, location, and other metadata information. Each metadata track thereby contains various sample entries and descriptions which provide information about the type of media data being referred to, followed by their timing and location and size information.

Subsequently, MPEG's video group and the Video Coding Experts Group (VCEG) of International Telecommunication Union (ITU) began working together as a Joint Video Team (JVT) to develop a new video coding/decoding (codec) standard. The new standard is referred to both as the ITU Recommendation H.264 or MPEG-4-Part 10, Advanced Video Codec (AVC). The encapsulation methods defined in the AVC file format can be used to store the coded video data, created by these specifications.

The JVT codec design distinguished between two different conceptual layers, the Video Coding Layer (VCL), and the Network Abstraction Layer (NAL). The VCL contains the coding related parts of the codec, such as motion compensation, transform coding of coefficients, and entropy coding. The output of the VCL is slices, each of which contains a series of video macroblocks and associated header information. The NAL abstracts the VCL from the details of the transport layer used to carry the VCL data. The NAL defines a generic and transport independent representation for information, and defines the interface between the video codec itself and the outside world. The JVT codec design specifies a set of NAL units, each of which contains different types of data.

In many existing video coding formats, the coded stream data includes various kinds of headers containing parameters that control the decoding process. For example, the MPEG-2 video standard includes sequence headers, enhanced group of pictures (GOP), and picture headers before the video data corresponding to those items. In JVT, the information needed to decode VCL data is grouped into parameter sets, and JVT defines an NAL unit that transports the parameter sets to the decoder. The parameter set NAL units may be sent in the same stream as the video NAL units (in-band) or in a separate stream (out-of-band).

The originally adopted H.264 Recommendation/ AVC specification defined three basic feature sets called profiles: baseline, main and extended. These profiles supported only video samples having 8 bits per sample and the chroma format YUV 4:2:0 used in consumer video such as television, DVD, streaming video, etc. Several new profiles, collectively called the fidelity range extensions (FRExt), were subsequently created to allow storage and management of professional video formats. FRExt specifies higher bit depth encoding, including 10 bit and 12 bit video samples, and additional chroma sampling formats, such as YUV 4:2:2 and 4:4:4. In addition, FRExt also specifies extra color spaces, such as the International Commission on Illumination (CIE) XYZ and RBG (red, green, blue) color spaces, in addition to the previously supported YCbCr (yellow, chroma-blue, chroma-red) color space.

Although the JVT team adopted the fidelity range extensions into their specifications, the H.264 Recommendation/AVC specification itself does not define how the existing AVC file format is to be modified to incorporate the new parameters associated with the extensions.

### SUMMARY OF THE INVENTION

A parameter set is created to specify chroma format, luma bit depth, and chroma bit depth for a portion of multimedia data. The parameter set is encoded into a metadata file that is associated with the multimedia data. The parameter set is extracted from the metadata file if a decoder configuration record contains fields corresponding to the parameter set. In another aspect, the decoder configuration record is created with fields corresponding to the parameter set.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of one embodiment of an encoding system;

FIG. 2 is a block diagram of one embodiment of a decoding system;

FIG. 3 is a block diagram of a computer environment suitable for practicing the invention;

FIG. 4 is a flow diagram of a method for storing parameter set metadata at an encoding system; and

FIG. 5 is a flow diagram of a method for utilizing parameter set metadata at a decoding system.

### DETAILED DESCRIPTION OF THE INVENTION

In the following detailed description of embodiments of the invention, reference is made to the accompanying drawings in which like references indicate similar elements, and in which is shown, by way of illustration, specific embodiments in which the invention may be practiced. These embodiments are described in sufficient detail to enable those skilled in the art to practice the invention, and it is to be understood that other embodiments may be utilized and that logical, mechanical, electrical, functional and other changes may be made without departing from the scope of the present invention. The following detailed description is, therefore, not to be taken in a limiting sense, and the scope of the present invention is defined only by the appended claims.

To support the fidelity range extensions set forth in the AVC specification, the decoder configuration record in the AVC file format is extended to specify the chroma format, luma bit depth, and chroma bit depth for a portion of multimedia data. The parameter set associated with a FRExt profiles is encoded into a metadata file that is associated with the multimedia data. The parameter set is extracted from the metadata file if the decoder configuration record contains fields corresponding to the presence of FRExt data.

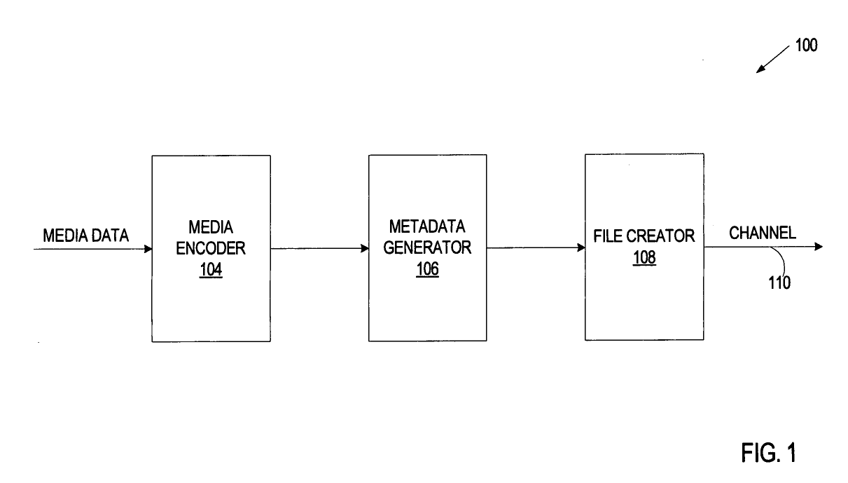

Beginning with an overview of the operation of the invention, FIG. 1 illustrates one embodiment of an encoding system 100 that generates parameter set metadata. The encoding system 100 includes a media encoder 104, a metadata generator 106 and a file creator 108. The media encoder 104 receives media data that may include video data (e.g., video objects created from a natural source video scene and other external video objects), audio data (e.g., audio objects created from a natural source audio scene and other external audio objects), synthetic objects, or any combination of the above. The media encoder 104 may consist of a number of individual encoders or include sub-encoders to process various types of media data. The media encoder 104 codes the media data and passes it to the metadata generator 106. The metadata generator 106 generates metadata that provides information about the media data. For AVC, the metadata is formatted as parameter set NAL units.

The file creator 108 stores the metadata in a file whose structure is defined by the media file format. The media file format may specify that the metadata is stored in-band or entirely or partially out-of band. Coded media data is linked to the out-of-band metadata by references contained in the metadata file (e.g., via URLs). The file created by the file creator 108 is available on a channel 110 for storage or transmission.

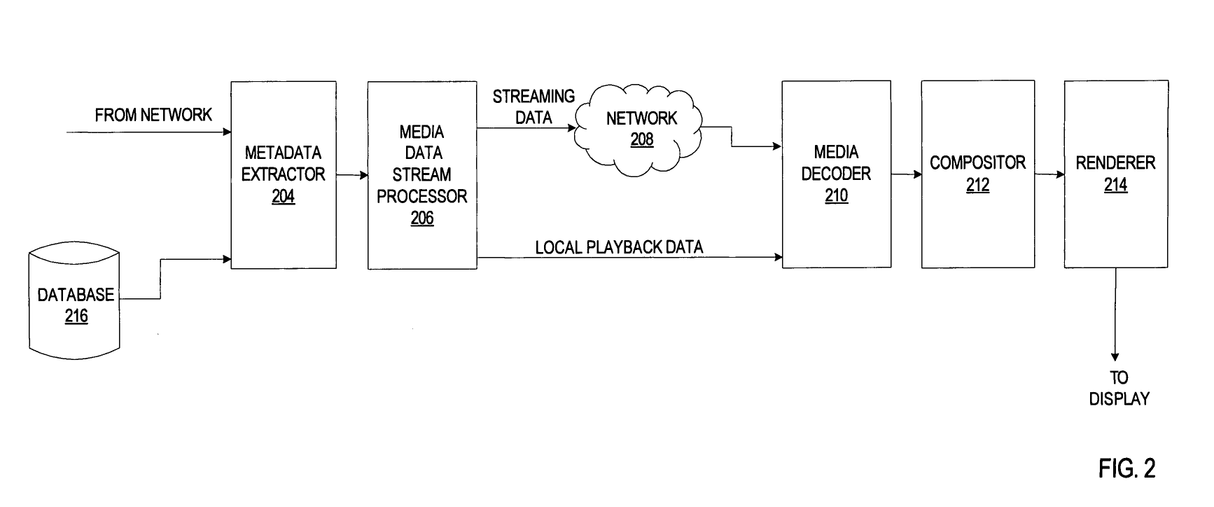

FIG. 2 illustrates one embodiment of a decoding system 200 that extracts parameter set metadata. The decoding system 200 includes a metadata extractor 204, a media data stream processor 206, a media decoder 210, a compositor 212 and a renderer 214. The decoding system 200 may reside on a client device and be used for local playback. Alternatively, the decoding system 200 may be used for streaming data, with a server portion and a client portion communicating with each other over a network (e.g., Internet) 208. The server portion may include the metadata extractor 204 and the media data stream processor 206. The client portion may include the media decoder 210, the compositor 212 and the renderer 214.

The metadata extractor 204 is responsible for extracting metadata from a file stored in a database 216 or received over a network (e.g., from the encoding system 100). A decoder configuration record specifies the metadata that the metadata extractor 204 is capable of handling. Any additional metadata that is not recognized is ignored.

The extracted metadata is passed to the media data stream processor 206 which also receives the associated coded media data. The media data stream processor 206 uses the metadata to form a media data stream to be sent to the media decoder 210.

Once the media data stream is formed, it is sent to the media decoder 210 either directly (e.g., for local playback) or over a network 208 (e.g., for streaming data) for decoding. The compositor 212 receives the output of the media decoder 210 and composes a scene which is then rendered on a user display device by the renderer 214.

The metadata may change between the time it is created and the time it is used to decode a corresponding portion of media data. If such a change occurs, the decoding system 200 receives a metadata update packet specifying the change. The state of the metadata before and after the update is applied is maintained in the metadata.

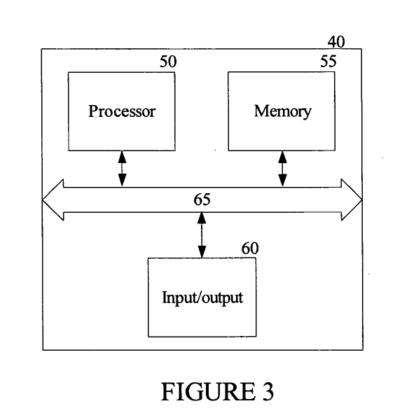

The following description of FIG. 3 is intended to provide an overview of computer hardware and other operating components suitable for implementing the invention, but is not intended to limit the applicable environments. FIG. 3 illustrates one embodiment of a computer system suitable for use as a metadata generator 106 and/or a file creator 108 of FIG. 1, or a metadata extractor 204 and/or a media data stream processor 206 of FIG. 2.

The computer system 340 includes a processor 350, memory 355 and input/output capability 360 coupled to a system bus 365. The memory 355 is configured to store instructions which, when executed by the processor 350, perform the methods described herein. Input/output 360 also encompasses various types of machine-readable media, including any type of storage device that is accessible by the processor 350. One of skill in the art will immediately recognize that the term “machine-readable medium/media” further encompasses a carrier wave that encodes a data signal. It will also be appreciated that the system 340 is controlled by operating system software executing in memory 355. Input/output and related media 360 store the computer-executable instructions for the operating system and methods of the present invention. Each of the metadata generator 106, the file creator 108, the metadata extractor 204 and the media data stream processor 206 that are shown in FIGS. 1 and 2 may be a separate component coupled to the processor 350, or may be embodied in computer-executable instructions executed by the processor 350. In one embodiment, the computer system 340 may be part of, or coupled to, an ISP (Internet Service Provider) through input/output 360 to transmit or receive media data over the Internet. It is readily apparent that the present invention is not limited to Internet access and Internet web-based sites; directly coupled and private networks are also contemplated.

It will be appreciated that the computer system 340 is one example of many possible computer systems that have different architectures. A typical computer system will usually include at least a processor, memory, and a bus coupling the memory to the processor. One of skill in the art will immediately appreciate that the invention can be practiced with other computer system configurations, including multiprocessor systems, minicomputers, mainframe computers, and the like. The invention can also be practiced in distributed computing environments where tasks are performed by remote processing devices that are linked through a communications network.

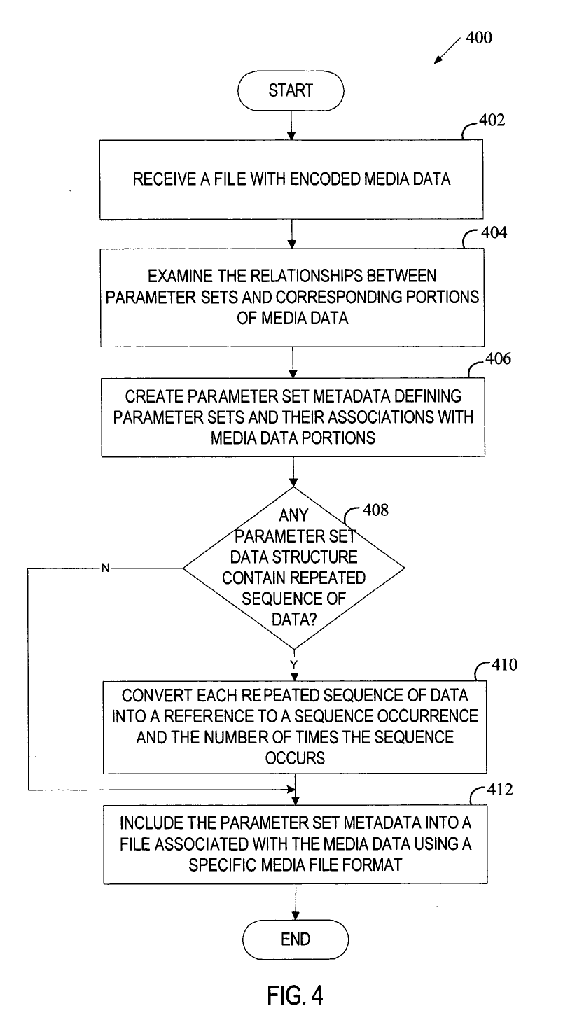

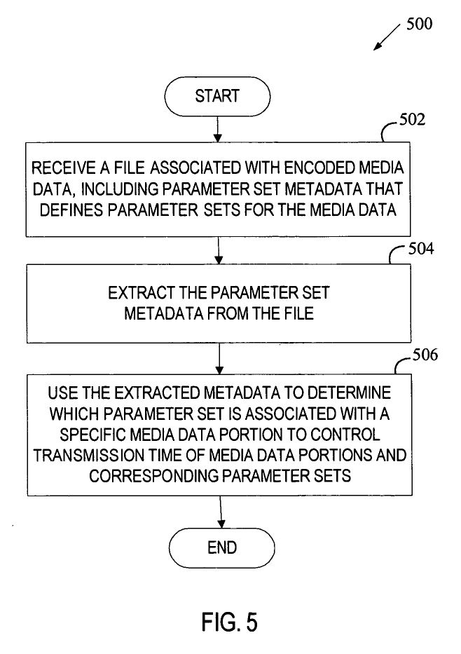

FIGS. 4 and 5 illustrate processes for storing and retrieving parameter set metadata that are performed by the encoding system 100 and the decoding system 200 respectively. The processes may be performed by processing logic that may comprise hardware (e.g., circuitry, dedicated logic, etc.), software (such as run on a general purpose computer system or a dedicated machine), or a combination of both. For software-implemented processes, the description of a flow diagram enables one skilled in the art to develop such programs including instructions to carry out the processes on suitably configured computers (the processor of the computer executing the instructions from computer-readable media, including memory). The computer-executable instructions may be written in a computer programming language or may be embodied in firmware logic. If written in a programming language conforming to a recognized standard, such instructions can be executed on a variety of hardware platforms and for interface to a variety of operating systems. In addition, the embodiments of the present invention are not described with reference to any particular programming language. It will be appreciated that a variety of programming languages may be used to implement the teachings described herein. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or produce a result. It will be appreciated that more or fewer operations may be incorporated into the processes illustrated in FIGS. 4 and 5 without departing from the scope of the invention and that no particular order is implied by the arrangement of blocks shown and described herein.

FIG. 4 is a flow diagram of one embodiment of a method 400 for creating parameter set metadata at the encoding system 100. The processing logic of block 402 receives a file with encoded media data, which includes sets of encoding parameters that specify how to decode portions of the media data. The processing logic examines the relationships between the sets of encoding parameters and the corresponding portions of the media data (block 404), and creates metadata defining the parameter sets and their associations with the media data portions (block 406).

In one embodiment, the parameter set metadata is organized into a set of predefined data structures. The set of predefined data structures may include a data structure containing descriptive information about the parameter sets, and a data structure containing information that defines associations between media data portions and corresponding parameter sets.

In one embodiment, the processing logic determines whether any parameter set data structure contains a repeated sequence of data (block 408). If this determination is positive, the processing logic converts each repeated sequence of data into a reference to a sequence occurrence and the number of times the sequence occurs (block 410). This type of parameter set is referred to as a sequence parameter set.

At block 412, the processing logic incorporates the parameter set metadata in a file associated with media data using a specific media file format (e.g., the AVC file format). Depending on the media file format, the parameter set metadata may be in-band or out-of-band.

FIG. 5 is a flow diagram of one embodiment of a method 500 for utilizing parameter set metadata at the decoding system 200. The processing logic at block 502 receives a file associated with encoded media data. The file may be received from a database (local or external), the encoding system 100, or from any other device on a network. The file includes the parameter set metadata that defines parameter sets for the corresponding media data. The processing logic of block 504 extracts the parameter set metadata from the file.

The processing logic at block 506 uses the extracted metadata to determine which parameter set is associated with a specific media data portion. The information in the parameter set controls decoding and transmission time of media data portions and corresponding parameter sets.

In response to the adoption of the JVT fidelity range extension (FRExt) profiles, chroma format and bit depth parameters have been created to incorporate the FRExt into the existing AVC sequence parameter sets by the JVT team. If a video sample is in one of the extended chroma formats such as YUV 4:2:2 or 4:4:4, a chroma format indicator, “chroma_format_idc,” is included in the corresponding sequence parameter set by the metadata generator 106 of FIG. 1 when executing blocks 406 through 410 of method 400. The chroma_format_idc parameter specifies the chroma (hue and saturation) sampling relative to the luma (luminosity) sampling and has a value ranging from 0 to 3. The presence of 10 and 12 bit video samples are indicated by two additional parameters, bit_depth_luma_minus8 specifies the bit depth of the luma samples, and bit_depth_chroma_minus8 specifies the bit depth of the chroma samples. The values of the bit_depth_luma_minus8 and bit_depth_chroma_minus8 parameters range from 0 to 4 according to the following formulas:

| | |
|---|---|
| BitDepth = 8+ bit_depth_luma_minus8 | (1) |
| BitDepth = 8+ bit_depth_chroma_minus8 | (2) |

Thus, a value of zero corresponds to a bit depth of 8 bits, while a value of 4 corresponds to a bit depth of 12 bits.

Corresponding changes are required to the AVC decoder configuration records in the AVC file format for decoders that are capable of processing media formats specified by the fidelity range extensions. In one embodiment, the class AVCDecoderConfigurationRecord is modified by adding the following fields:

bit (6) reserved =‘111111’b;
unsigned int(2) chroma_format;
bit (5) reserved =‘11111’b;
unsigned int (3) bit_depth_luma_minus8;
bit (5) reserved =‘11111’b;
unsigned int (3) bit_depth_chroma_minus8;

where the chroma_format field contains the chroma format indicator defined by the parameter chroma_format_idc. The other two fields contain the corresponding luma and chroma parameter values.

Assuming the decoder 210 of FIG. 2 is capable of decoding video in the extended formats, the modified decoder configuration record controls the extraction of the new FRExt parameters by the metadata extractor 204 as it executes block 505 of method 500.

Storage and retrieval of audiovisual metadata has been described. Although specific embodiments have been illustrated and described herein in terms of the AVC file formats, it will be appreciated by those of ordinary skill in the art that any arrangement which is calculated to achieve the same purpose may be substituted for the specific embodiments shown. This application is intended to cover any adaptations or variations of the present invention.

What is claimed is:

1. A computerized method comprising:
creating a parameter set for a portion of multimedia data, wherein the parameter set comprises parameters specifying chroma format, luma bit depth and chroma bit depth for the portion of the multimedia data; and
encoding the parameter set into a metadata file that is associated with the multimedia data.

2. The method of claim 1, wherein the portion of the multimedia data comprises a video sample encoded with the chroma format and bit depths.

3. The method of claim 1, wherein creating the parameter set comprises:
creating first data structure containing descriptive information about the parameter set and a second data structure containing information that defines an association between the parameter set and the portion of the multimedia data.

4. The method of claim 1 further comprising:
receiving the metadata file; and
extracting the parameter set from the metadata file, wherein the chroma format and bit depth parameters are ignored if a decoder configuration record does not include corresponding fields.

5. A computerized method comprising:
receiving a metadata file associated with a portion of multimedia data, the metadata file comprising a parameter set specifying chroma format, luma bit depth and chroma bit depth for the portion of the multimedia data; and
extracting the parameter set from the metadata file, wherein the chroma format and bit depth parameters are ignored if a decoder configuration record does not include corresponding fields.

6. The method of claim 5, wherein the portion of the multimedia data comprises a video sample encoded with the chroma format and bit depths.

7. A computerized method comprising:
creating a decoder configuration record comprising metadata entries corresponding to parameters for chroma format, a luma bit depth and a chroma bit depth for multimedia data.

8. The method of claim 7 further comprising:
inserting the decoder configuration record into a decoder that processes multimedia data encoded with chroma format and bit depths specified by the parameters.

9. A machine-readable medium having executable instructions to cause a processor to perform a method comprising:
creating a parameter set for a portion of multimedia data, wherein the parameter set comprises parameters specifying chroma format, luma bit depth and chroma bit depth for the portion of the multimedia data; and
encoding the parameter set into a metadata file that is associated with the multimedia data.

10. The machine-readable medium of claim 9, wherein the portion of the multimedia data comprises a video sample encoded with the chroma format and bit depths.

11. The machine-readable medium of claim 9, wherein creating the parameter set comprises:
creating first data structure containing descriptive information about the parameter set and a second data structure containing information that defines an association between the parameter set and the portion of the multimedia data.

12. The machine-readable medium of claim 9, wherein the method further comprises:
receiving the metadata file; and
extracting the parameter set from the metadata file, wherein the chroma format and bit depth parameters are ignored if a decoder configuration record does not include corresponding fields.

13. A machine-readable medium having executable instructions to cause a processor to perform a method comprising:
receiving a metadata file associated with a portion of multimedia data, the metadata file comprising a parameter set specifying chroma format, luma bit depth and chroma bit depth for the portion of the multimedia data; and
extracting the parameter set from the metadata file, wherein the chroma format and bit depth parameters are ignored if a decoder configuration record does not include corresponding fields.

14. The machine-readable medium of claim 13, wherein the portion of the multimedia data comprises a video sample encoded with the chroma format and bit depths.

15. A machine-readable medium having executable instructions to cause a processor to perform a method comprising:
creating a decoder configuration record comprising metadata entries corresponding to parameters for chroma format, a luma bit depth and a chroma bit depth for multimedia data.

16. A system comprising:
a processor coupled to a memory through a bus; and
a process executed from the memory by the processor to cause the processor to create a parameter set for a portion of multimedia data, wherein the parameter set comprises parameters specifying chroma format, luma bit depth and chroma bit depth for the portion of the multimedia data, and encode the parameter set into a metadata file that is associated with the multimedia data.

17. The system of claim 16, wherein the portion of the multimedia data comprises a video sample encoded with the chroma format and bit depths.

18. The system of claim 16, wherein creating the parameter set comprises:
creating first data structure containing descriptive information about the parameter set and a second data structure containing information that defines an association between the parameter set and the portion of the multimedia data.

19. The system claim 16, wherein the process further causes the processor to receive the metadata file, and extract the parameter set from the metadata file, wherein the chroma format and bit depth parameters are ignored if a decoder configuration record does not include corresponding fields.

20. A system comprising:
a processor coupled to a memory through a bus; and
a process executed from the memory by the processor to cause the processor to receive a metadata file associated with a portion of multimedia data, the metadata file comprising a parameter set specifying chroma format, luma bit depth and chroma bit depth for the portion of the multimedia data, and extract the parameter set from the metadata file, wherein the chroma format and bit depth parameters are ignored if a decoder configuration record does not include corresponding fields.

21. The system of claim 20, wherein the portion of the multimedia data comprises a video sample encoded with the chroma format and bit depths.

22. A system comprising:
a processor coupled to a memory through a bus; and
a process executed from the memory by the processor to cause the process to create a decoder configuration record comprising metadata entries corresponding to parameters for chroma format, a luma bit depth and a chroma bit depth for multimedia data.
